(19) United States
(12) Patent Application Publication
(10) Pub. No.: US 2009/0274018 A1
(43) Pub. Date: Nov. 5, 2009

(54) RECORDING DEVICE AND RADIAL OFFSET CALIBRATION METHOD

(75) Inventor: Yu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/295,764

(22) PCT Filed: Apr. 4, 2007
(86) PCT No.: PCT/IB07/51199

§ 371 Date: Oct. 3, 2008

(30) Foreign Application Priority Data
Apr. 5, 2006 (EP) 06112242.0

(51) Int. Cl. G11B 7/00

(52) U.S. Cl. 369/44.13; G9B/7

(57) ABSTRACT

The present invention relates to a method of calibrating a radial offset of an optical recorder after a recordable record carrier is inserted (1000), the method comprising the steps of: determining wobble signal amplitudes at different radial offset values of a radial control loop (102), finding an optimal radial offset value at which the wobble signal amplitude is substantially maximal (104), and recording the data on at least one wobbled recording track (T1, T2, T3, . . . Tn) of the recordable record carrier using the optimal radial offset value (106). This is useful for all optical recording devices.

The invention relates to recording devices and more specifically to radial offset calibration methods.

Yoshiyuki Otsuka et. al (US2003/0026175) teach a method of writing data onto an optical disc having a track that undulates with a predetermined periodicity. In their method, the presence of a track deviation and the direction of the track deviation are determined based on the phase of the wobble component. When it is determined that there is a track deviation in a radially inward direction, an offset is added to the tracking error signal by an offset adding circuit so that the optical pick up (laser/light spot) moves radially outward. On the other hand, when it is determined that there is a track deviation in a radially outward direction, an offset is added to the tracking error signal by an offset adding circuit so that the optical pickup (laser/light spot) moves radially inward. In this manner, the optical disc device corrects the tracking error and controls the laser/light spot to be on the centre of the recording track. Yoshiyuki Otsuka's method has disadvantages. When the deviation of the light spot from the centre of the recording track is not very significant, it is difficult to decide whether it is a noise signal or a wobble component. If the wobble component is large enough to show the tracking deviation, then this could already trigger radial off track detection. Furthermore, due to the variation in the optical media, write strategy variations, digital signal-processing noise, and measurement noise, the signal-to-noise ratio of the wobble component is very low. This makes it difficult to get the correct wobble component and the phase of the wobble component. Furthermore, the digital signal-processing must be fast, i.e. in the GHz range, in order to get accurate correction of the radial offset, which is difficult. Hence, their method requires additional processing effort.

It would be advantageous to have a method that minimizes the processing effort for achieving better tracking performance during recording. It would also be advantageous to have a device that minimizes the processing effort for achieving better tracking performance during recording. It would also be advantageous to have a computer program code means that minimizes the processing effort for achieving better tracking performance during recording.

Accordingly, a method of calibrating a radial offset of an optical recorder after a recordable record carrier is inserted is described herein. Wobble signal amplitudes are determined at different radial offset values of a radial control loop. An optimal radial offset value is found at which the wobble signal amplitude is substantially maximal. The data is recorded on at least one wobbled recording track (T₁, T₂, T₃, . . . Tₙ) of the recordable record carrier using the optimal radial offset value.

According to the invention, a relationship between the wobble signal amplitude on a blank recordable record carrier and the radial offset is found. The wobble signal amplitude shows a bathtub-shaped relation with radial offset. Calibrating the radial offset according to the maximum wobble amplitude during recording overcomes the recording errors that are caused due to inaccurate detection of the phase of the wobble component. Tracking performance and wobble quality is improved during recording. The method needs the wobble signal and means for varying the radial offset. The method is computationally simple and requires less processing effort. The wobble signal is obtained using circuits available in the optical recorder. The radial offset varying circuit is also available in the optical recorder and does not add to the cost of the optical recorder. Accordingly, the processing operation, namely,

i. wobble component detection for detecting a wobble component; and
ii. addition operation for adding the wobble signal and the wobble component,
which is carried out in the prior art optical disc device (US2003/0026175), is not necessary. This decreases the processing effort and increases the processing speed. The risk of picking up the noise component instead of the wobble component and setting the radial offset, which causes recording errors, is overcome. Furthermore, the risk of triggering a radial off track detection to show the tracking deviation, if the wobble component is not very large, is overcome. Furthermore, the method is carried out on the fly so that the radial offset is always compensated for recording.

Further, an optical recording device for calibrating a radial offset after a recordable record carrier is inserted is described herein. An optical system scans wobbled recording tracks (T₁, T₂, T₃, . . . Tₙ) of the recordable record carrier. The optical system comprises light beam generating means, an objective lens for focusing a light beam on the recordable record carrier, an optical detector for detecting a reflected light beam, a controllable radial actuator for radially displacing the objective lens with respect to the wobbled recording tracks (T₁, T₂, T₃, . . . Tₙ) of the recordable record carrier. A control circuit having an input for receiving an input signal from the optical detector and having an output coupled to a control input of said radial actuator is adapted to perform a radial offset calibration method according to the invention.

Further, a computer program code means for performing the method of calibrating the radial offset of an optical recorder is described herein. This aspect of the invention is particularly, but not exclusively, advantageous in that the present invention may be implemented by a computer program code means enabling a computer system to perform the radial offset calibration method according to the invention. Thus, it is contemplated that some known optical recorders may be changed to operate according to the present invention by installing a computer program code means on a computer system controlling the said optical recorder. Such a computer program code means may be provided on any kind of computer readable medium, e.g. magnetic or optical based medium.

These and other aspects, features and advantages of the invention will be further explained by the following description, by way of example only, with reference to the accompanying drawings, in which same reference numerals indicate same or similar parts, and in which:

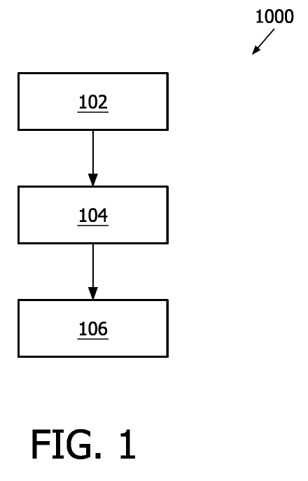

FIG. 1 is a flow chart illustrating the steps of the method of calibrating a radial offset of an optical recorder,

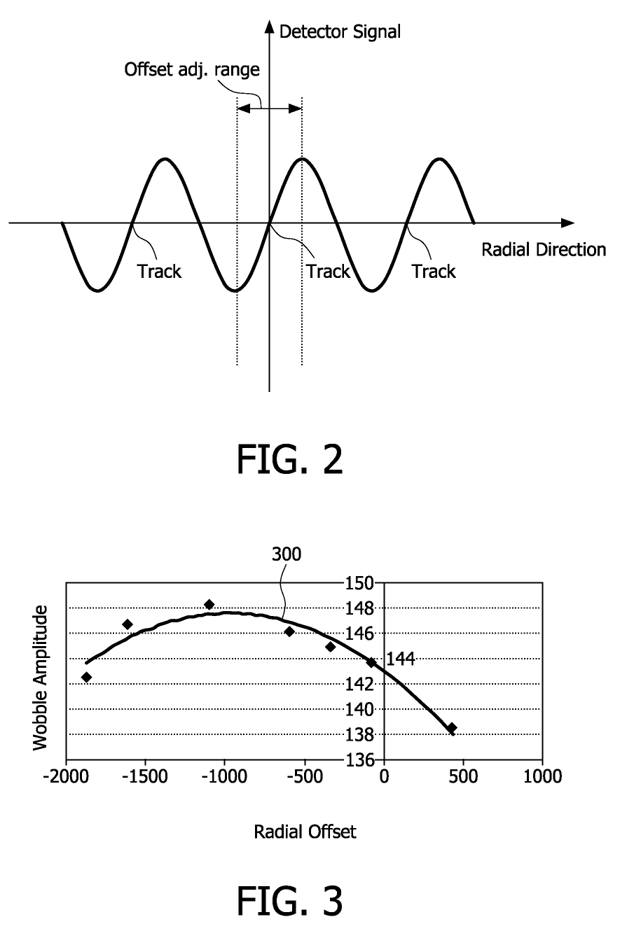

FIG. 2 illustrates schematically the computation of the step-size, the maximum allowable radial offset value and the minimum allowable radial offset value,

FIG. 3 is a graph, illustrating schematically the relationship between wobble signal amplitude and radial offset, obtained for a DVD+R DL record carrier at layer 1,

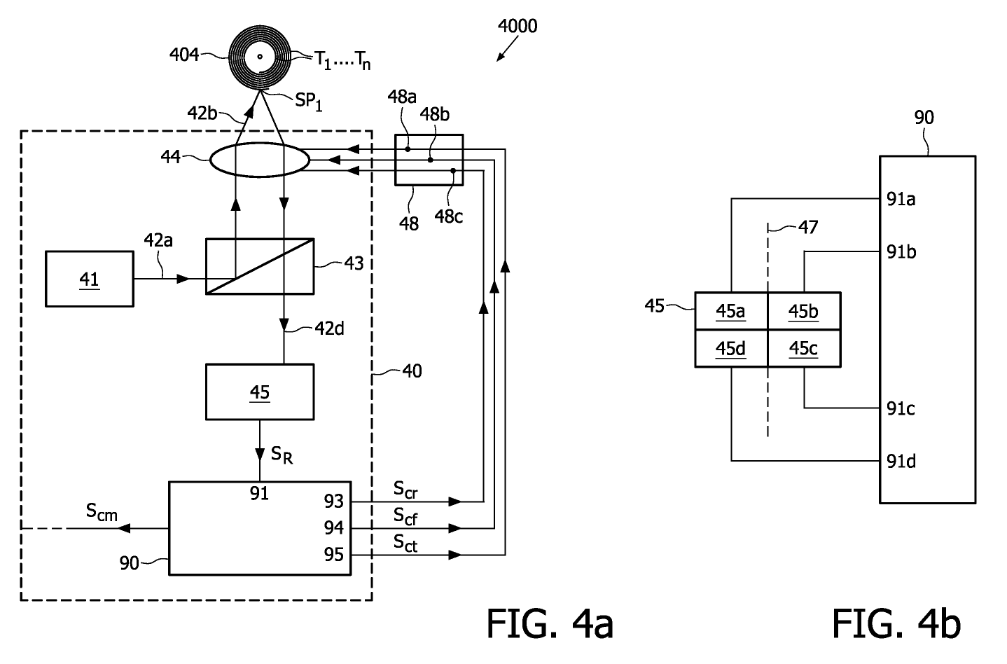

FIGS. 4a and 4b schematically illustrate an optical recording device, and

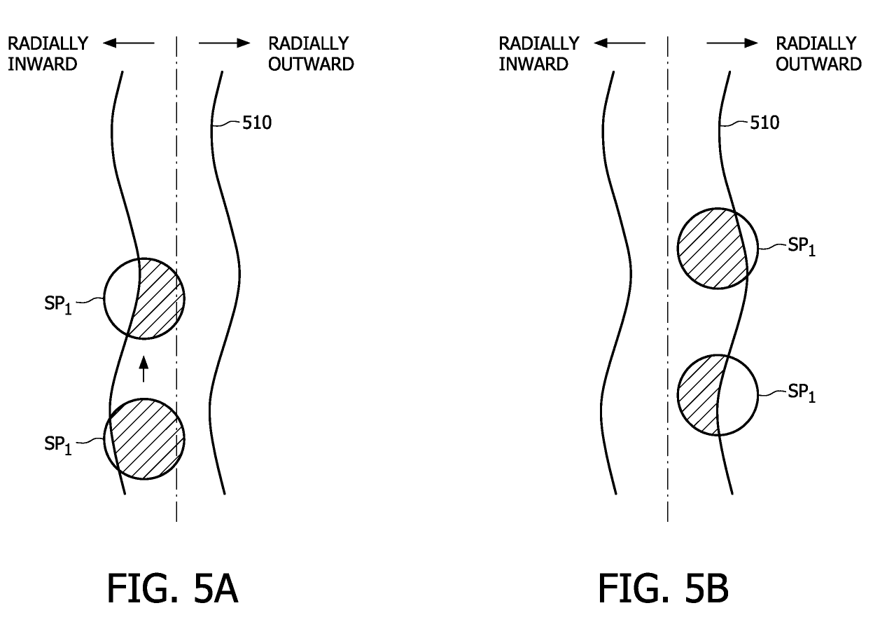

FIGS. 5A and 5B schematically illustrate the relationship between a wobble and a spot of laser light for recording.

As is commonly known, a recordable record carrier, e.g. CD, DVD, Blu-ray disc, comprises at least one wobbled track, either in the form of a continuous spiral or in the form of multiple concentric circles, where information may be stored in the form of a data pattern. For writing onto the wobbled track of the record carrier, an optical recording device comprises, on the one hand, rotating means for rotating the record carrier, and, on the other hand, optical means for generating an optical beam, typically a laser/light beam, and for scanning the wobbled track with said laser/light beam. For rotating the record carrier, the optical recorder typically comprises a motor. For optically scanning the rotating record carrier, the optical recorder comprises a light beam generator (typically a laser diode), an objective lens for focussing the light beam to a spot on the record carrier, and an optical detector for generating an electrical detector output signal. During operation of the optical recorder, the light/laser beam should remain focussed on a spot on the record carrier. To this end, the objective lens is arranged so as to be axially displaceable, and the optical recorder comprises focus actuator means for controlling the axial position of the objective lens. Further, the spot should remain aligned with a track or should be capable of being positioned with respect to a track. To this end, the objective lens is radially displaceable, and the optical recorder comprises radial actuator means for controlling the radial position of the objective lens. While recording data on the wobbled recording tracks of the record carrier, there may be situations where a pit is not formed at the centre of a recording track on the record carrier, because of substantial tolerances in optical, electrical and mechanical properties of the record carrier, e.g. unevenness of the record carrier, material characteristics of the record carrier and wavelength shift in a laser diode. Data is recorded at a position deviated from the centre of the recording track. It is unknown whether the laser/light spot should be moved outward or inward with respect to the centre of the recording track. This deviation of the laser/light spot from the centre of the recording track is referred to as radial offset. This radial offset not only affects the record carrier recording quality, but also the record carrier reading quality.

FIG. 1 is a flowchart of a method 1000 of calibrating a radial offset of an optical recorder, typically a DVD recorder. For ensuring a good tracking performance, the light/laser spot should always be focussed on the centre of the recording track. In order to achieve this, a radial offset calibration method is proposed which is easy to implement and which is carried out on the fly so that the radial offset is always compensated for recording. In step 102, wobble signal amplitudes are determined at different radial offset values of a radial control loop. In step 104, an optimal radial offset value at which the wobble signal amplitude is substantially maximal is determined. In step 106, the data is recorded on at least one wobbled recording track (T₁, T₂, T₃, . . . Tₙ) of the recordable record carrier, using the optimal radial offset.

In one possible embodiment, the step of determining wobble signal amplitudes at different radial offset values of a radial control loop further comprises the following: obtaining an initial radial offset value on the basis of a calibration procedure carried out during initial start up of the optical recorder. This initial radial offset value is obtained by reading the recordable record carrier, wherein the recordable record carrier is a blank recordable record carrier or a recordable record carrier that is partly written and partly blank. Next, a step-size, a maximum allowable radial offset value and a minimum allowable radial offset value is obtained. The procedure for obtaining these values is schematically illustrated in FIG. 2. During recording, since a push-pull tracking method is used, the radial tracking error signal is as shown in FIG. 2. The step-size is calculated according to the ramping range and the number of points needed to obtain good calibration results. The radial offset adjustment is basically set to radial error in the linear operating range, i.e. ¼^{th} of the radial tracking pitch width. Based on this, the step-size, the minimum allowable radial offset value and the maximum allowable radial offset value is obtained. The other factor that is considered for obtaining the step-size is the total available time for calibration. After having obtained the step-size, the minimum allowable radial offset value and the maximum allowable radial offset value, the wobble signal amplitude at different radial offset values is determined, which involves the following steps, and a possible result of this procedure is schematically illustrated in FIG. 3:
1. Start with the initial radial offset value.
2. Set radial offset varying mode to ramping up mode.
3. Set radial offset=radial offset+step-size.
4. Enable angular interrupt for one revolution.
5. Read wobble amplitude from decode register.
6. Calculate average wobble signal amplitude.
7. Repeat steps 3 to 6 until maximum radial offset value is reached.
8. Reset radial offset value to initial radial offset value.
9. Set radial offset varying mode to ramping down mode.
10. Set radial offset=radial offset−step-size.
11. Enable angular interrupt for one revolution.
12. Read wobble signal amplitude from decode register.
13. Calculate average wobble signal amplitude.
14. Repeat steps 10 to 13 until minimum radial offset value is reached.
15. Curve-fit the values of the radial offset and the wobble signal amplitude and find the optimal radial offset value.

FIG. 3 is a graph, schematically illustrating an example of calibration results obtained using the above procedure. The average wobble signal amplitude (vertical axis) is plotted against the corresponding radial offset (horizontal axis). The boxes indicate the measured values.

As should be clear to a person skilled in the art, any function Y (X) having a maximum for X=Xₘ can, within a small range around this maximum Xₘ, be reasonably approximated by a quadratic function according to

Y(X)=c₀+c₁(X−Xₘ)+c₂(X−Xₘ)²

wherein c₀, c₁ and c₂ are constants. Finding an optimum fit for measurements Yᵢ (Xᵢ) is equivalent to finding optimum values for Xₘ, and c₀, c₁ and c₂. Usually, this is done by the well-known least squares method, which need not be explained here. In any case, it should be clear to a person skilled in the art that it is possible to calculate, on the basis of several measurements around the maximum of such a function, an optimum parabolic fit, and consequently it is possible to calculate Xₘ and Yₘ (Xₘ).

The radial offset calibration curve 300 in FIG. 3 illustrate such a parabolic fit. With the calibration data of X (radial offset values) and Y (wobble signal amplitude), the coefficients c₀, c₁ and c₂ are calculated. After calculating the coefficients c₀, c₁ and c₂, the point Xₘ is calculated with Yₘ, as Xₘ=(−c₁/(2×c₂)); Then the radial offset is set to an optimal value corresponding to the maximum wobble signal amplitude value.

The result shown in FIG. 3 is only an example of the calibration results obtained for a DVD+R DL (dual layer) recordable record carrier at layer 1. The dual layer media is more sensitive to the dye material and deposition, groove shapes and silver deposition. The dual layer media parameters like signal amplitude and tracking signal are much larger than those of single layer media. That is the reason why the radial off track problem is seen more in DVD+R DL media than in other SL (single layer) recordable media. DVD+R DL is considered only for illustration, and the procedure is applicable to all types of optical disc media, e.g. write-once and write-many recordable types (CD-RW, DVD-RW, DVD+RW, Blu-ray discs). It is to be noted that the result may be different under different conditions. Setting the radial offset according to the maximum wobble signal amplitude during recording overcomes the recording errors that are caused due to inaccurate detection of the phase of the wobble component. In essence, the proposed calibration procedure is based on finding the relationship between the wobble signal amplitude on the blank record carrier and the radial offset. Furthermore, the invention provides a method of adjusting the radial offset on the fly during recording so that the best tracking performance for recording is achieved.

In one possible application, the method is performed periodically at the start of recording of each segment of the data, so that best tracking performance is always guaranteed for this period of recording. For recording data on the wobbled recording tracks of the recordable record carrier, the recording length depends on the data buffer size. Usually a recording is composed of many small segments of data. This makes on the fly radial offset adjustment possible during the start of recording of each segment of data.

In a further possible application, the method is performed while recording data on predetermined regions of the recordable record carrier to cater to the media variation across the record carrier, i.e. from inner region to outer region, so as to keep the radial tracking always at the best position to achieve the best recording quality.

In a still further possible application, the method is performed during recording test data on a power calibration area of the recordable record carrier. During optimum power calibration there is a possibility of

i. a radial off track condition,

ii. not achieving good tracking performance if the radial offset is not calibrated.

When the laser is more than ¼ track pitch away from the centre of the track, the radial control loop cannot keep the laser properly on track anymore. The tracking system will then open the radial control loop and repeat radial catching again. This is known as radial recovery. In this case, the optimum power calibration procedure cannot continue. Another radial off track condition is when the laser is still within ¼ track pitch range around the track centre, but not on the centre of the track. The recording will continue, but the recording quality will be affected, especially during optimum power calibration, when the laser power and write strategy is not optimised. This will cause subsequent laser calibration failure. This kind of radial offset will also affect the reading performance of the wobble address read back during recording, since the wobble read back is sensitive to radial off track. The radial off track detection sets the radial error threshold level, which corresponds to ¼ pitch. This threshold is set during the radial initialization at start up using a read laser. If this radial offset is not set properly, the radial off track detection system could wrongly trigger the radial recovery action during writing, and thus affect optimum power calibration results and recording performance. This will affect the optimum power calibration results, which are based on the writing quality in the power calibration area. Performing a radial offset calibration during optimum power calibration ensures that the recording power obtained is accurate. This will affect the optimum power calibration results, which are based on the writing quality in the power calibration area. Performing a radial offset calibration during optimum power calibration ensures that the recording power obtained is accurate.

In a still further possible application, the method is performed on detection of a radial off track problem during recording of the data on the recordable record carrier. This is advantageous in situations where the time available is not long enough to perform all of the calibrations, e.g. in addition to radial offset calibration, there are also focus offset calibration and tilt offset calibration. In such situations it is advantageous to use this radial offset calibration as a corrective action when an error is detected.

If the data buffer size for recording is large enough, there is enough time available to perform the calibration before the next recording can start. Hence, the application of performing the radial offset calibration on regions of the recordable record carrier should be chosen. On the other hand, if the time available is not long enough, then the application of performing the offset radial calibration during the recovery routine, i.e. on detecting a radial off track problem during recording of the data on the recordable record carrier, has to be chosen. This means that, on detecting a radial off track problem, during recording, the radial offset calibration is performed, and skipping to the next recording address takes place to continue recording. This is another way of performing a radial offset calibration during recording. Presently, if radial off track is detected, the system will carry out a radial recovery by switching off the radial control loop, and repeating radial capturing again after small track jumps. If the radial offset is not set properly, said radial recapturing can take more than 10 iterations of radial recovery actions and may finally lead to stopping of recording or hanging during recording. The proposed method will perform the radial offset calibration after the system detects an off track condition and before the drive system recaptures the radial again. After the radial offset calibration, the method will use the optimised radial offset to recapture the radial to close the radial loop again.

It is possible to perform the radial offset calibration using both of the possibilities mentioned above, i.e. on pre-determined regions of the record carrier and during recovery routine. This is suitable when: i. the record carrier is in a poor condition, ii. there is substantial variation across the record carrier, and iii. the resolution of the regions is not good enough.

FIGS. 4a and 4b schematically illustrate an optical recording device 4000, suitable for writing information onto a recordable record carrier 404, typically a DVD. For rotating the recordable record carrier 404, the optical recording device 4000 comprises a motor (not shown). The optical recording device 4000 further comprises an optical system 40 for scanning wobbled tracks (T₁, T₂, T₃, . . . Tₙ) of the recordable record carrier 404 by an optical beam. More specifically, the optical system 40 comprises a light beam generator means 41, typically a laser such as a laser diode, which is arranged to generate a light beam 42a, which passes a beam splitter 43 and an objective lens 44. The objective lens 44 focuses the light beam 42b on a spot SP₁ on the recordable record carrier 404. The light beam 42b reflects from the recordable record carrier 404 and passes the objective lens 44 and the beam splitter 43 to reach an optical detector 45. The optical recording device 4000 further comprises an actuator system 48, which comprises: i. a radial actuator 48a for radially displacing the objective lens 44 with respect to the wobbled recording tracks (T₁, T₂, T₃, . . . Tₙ) of the recordable record carrier 404 ii. a focal actuator 48b for controlling the focussing of the light spot SP₁, and iii. a tilt actuator 48c arranged for pivoting the objective lens 44 with respect to a recording reference plane of the recordable record carrier 404.

The optical recording device 4000 further comprises a control circuit 90 having a first output connected to a control input of the motor (not shown), a second output 93 coupled to a control input of the radial actuator 48a, a third output 94 coupled to a control input of a focal actuator 48b and a fourth output 95 coupled to a control input of the tilt actuator 48c. The control circuit 90 is designed to generate

iii. at its first output 92, a control signal S_{cm} for controlling the motor (not shown),

iv. at its second output 93, a control signal S_{cr} for controlling the radial actuator 48a,

v. at its third output 94, a control signal S_{cf} for controlling the focal actuator 48b, and

vi. at its fourth output 95, a control signal S_{ct} for controlling the tilt actuator 48c.

The control circuit 90 further has a read signal input 91 for receiving a read signal S_{R} from the optical detector 45. As shown in FIG. 4b, the optical detector 45 comprises a plurality of detector segments, in this case four detector segments, 45a, 45b, 45c, 45d, capable of providing individual detector signals A, B, C, D, respectively, indicating the amount of light incident on each of the four detector quadrants. A centre line 47 separating the first and fourth segments 45a and 45d from the second and third segments 45b and 45c is oriented according to the track direction. Such a four-quadrant detector is commonly known per se, therefore it is not necessary here to give a more detailed description of its design and functioning.

FIG. 4b illustrates that the read signal input 91 of the control circuit 90 actually comprises four inputs 91a, 91b, 91c, 91d for receiving said individual detector signals A, B, C, D respectively. The control circuit 90 is designed to process said individual detector signals A, B, C, D in order to derive data and control information. A one-spot push-pull tracking signal Sₜₑ can be obtained by summation of the signals A and B from all individual detector segments 45a and 45d on one side of the centre line 47, summation of signals B and C from all individual detector segment 45b and 45c on the other side of the centre line 47, and taking the difference of these two summations according to

Sₜₑ=(A+D)−(B+C).

Sₜₑ indicates amount and direction of the tracking error, which is the deviation of the light spot SP₁ from the centre of the recording track. In case of no offset, the two tracking error signals coincide with each other and with the centre of the recording track. The control circuit 90 takes the tracking error signal Sₜₑ and obtains an S_{cr} control signal for controlling the radial actuator 48a so that the light spot SP₁ is on the centre of the recording track. However, if the recordable record carrier 404 is skewed or the axis of the objective lens is not aligned to the centre line of the detector 45, a tracking error signal may still be formed, which is like a bias component and is called an offset. In other words, the offset is the radial deviation of the light spot SP₁ from the centre of the track. FIGS. 5A and 5B schematically illustrate the relationship between the wobble and the spot of laser light for recording. FIG. 5A shows a case where the light spot SP₁ deviates radially inward with respect to the centre line of the wobble 510 (shown in the Figure by a dot-dash line). Similarly, FIG. 5B shows a case where the light spot SP₁ deviates radially outward with respect to the centre line of the wobble 510.

The control circuit 90 is adapted to perform the radial offset calibration method according to the invention. The calibration procedure is explained in detail with reference to FIG. 1, FIG. 2, and FIG. 3 in the previous paragraphs. The control signal S_{cr} obtained after the radial offset calibration controls the radial actuator 48a such that the light spot SP₁ is always on the centre of the recording track.

Although the invention has been mainly explained with reference to embodiments using a DVD+R DL recordable record carrier, it is also suitable for other recordable record carriers, such as CD, Blu-ray disc that uses a light spot for recording data on the wobbled tracks of the disc. A person skilled in the art can implement the described embodiments of the method of calibrating radial offset in software or in both hardware and software. It will, however, be evident that various modifications and changes may be made without departing from the broader scope of the invention, as set forth in the appended claims. Use of the verb “comprise” does not exclude the presence of elements other than those stated in a claim or in the description. Use of the indefinite article “a” or “an” preceding an element or step does not exclude the presence of a plurality of such elements or steps. The Figures and description are to be regarded as illustrative only and may not be used to limit the invention.

In summary, the invention provides a method of calibrating a radial offset of an optical recorder after a recordable record carrier is inserted, the method comprising the steps of: determining wobble signal amplitudes at different radial offset values of a radial control loop, finding an optimal radial offset value at which the wobble signal amplitude is substantially maximal, and recording the data on at least one wobbled recording track (T₁, T₂, T₃, . . . Tₙ) of the recordable record carrier using the optimal radial offset value. This is useful for all optical recording devices.

1. A method of calibrating a radial offset of an optical recorder after a recordable record carrier is inserted (1000), the method comprising the steps of: determining wobble signal amplitudes at different radial offset values of a radial control loop; finding an optimal radial offset value at which the wobble signal amplitude is substantially maximal; recording the data on at least one wobbled recording track (T1, T2, T3, . . . Tn) of the recordable record carrier using the optimal radial offset value.

2. The method of claim 1, wherein the step of determining wobble signal amplitudes at different radial offset values of a radial control loop further comprises: obtaining an initial radial offset value on the basis of a calibration procedure carried out during initial start up of the optical recorder; obtaining a step-size, a maximum allowable radial offset value and a minimum allowable radial offset value; setting the radial offset to the initial radial offset value; varying the radial offset radially outward by one step-size until the maximum allowable radial offset value is reached, and, for each variation of the radial offset value, reading a corresponding wobble signal amplitude value; re-setting the radial offset to the initial radial offset value; and varying the radial offset value radially inward by one step-size until the minimum allowable radial offset value is reached, and, for each variation of the radial offset value, reading a corresponding wobble signal amplitude value.

3. The method of claim 1, wherein the method is performed periodically at the start of recording of each segment of the data.

4. The method of claim 1, wherein the method is performed while recording the data on pre-determined regions of the recordable record carrier.

5. The method of claim 1, wherein the method is performed during recording test data on a power calibration area of the recordable record carrier.

6. The method of claim 1, wherein the method is performed on detection of a radial off track problem during recording of the data on the recordable record carrier.

7. The method of claim 1, wherein the method is performed on a recordable DVD disc.

8. An optical recording device (4000) comprising: an optical system (40) for scanning wobbled recording tracks (T1, T2, T . . . Tn) of a recordable record carrier, which optical system (40) comprises light beam generating means (41), an objective lens (44) for focusing a light beam (42b) on the recordable record carrier, an optical detector (45) for detecting a reflected light beam (42d); a controllable radial actuator (48a) for radially displacing the objective lens (44) with respect to the wobbled recording tracks (T1, T2, T3, . . . Tn) of the recordable record carrier; a control circuit (90) having an input (91) for receiving an input signal (SR) from the optical detector (45) and having an output (93) coupled to a control input of said radial actuator (48a); and wherein the control circuit (90) is adapted to perform a radial offset calibration method according to claim 1.

9. The optical recording device of claim 8, wherein the optical recording device is a DVD recorder.

10. A computer program comprising program code means for performing the method of claim 1 when said program is run on a computer.
